(19) United States
(12) Patent Application Publication
(10) Pub. No.: US 2005/0249858 A1
(43) Pub. Date: Nov. 10, 2005

(54) XYLITOL COATED FUNCTIONAL DIETARY FIBER SUPPLEMENT

(76) Inventor: Jong Kyun Lee, Seoul (KR)

Correspondence Address: JHK LAW, P.O. BOX 1078, LA CANADA, CA, 91012-1078, US

(21) Appl. No.: 10/908,258

(22) Filed: May 4, 2005

(30) Foreign Application Priority Data
May 7, 2004 (KR) 2004-32177
Sep. 14, 2004 (KR) 2004-73561

(51) Int. Cl. C12C 1/00

(52) U.S. Cl. 426/615

(57) ABSTRACT

The present invention involves a new functional dietary fiber supplement for intestinal health. Unlike conventional products made of plain psyllium husks, the xylitol coating makes oral consumption very convenient. The ground psyllium husk used in this invention is exceptionally effective at facilitating intestinal functions and increasing feces volume. The refreshing flavor of xylitol shields the original smell of psyllium and enhances the product so that it corresponds well with modern taste. When consumed properly, this invention can contribute much to the maintenance of a healthy digestive tract.

### BACKGROUND OF THE INVENTION

1. Field of the Invention

The present invention is a functional dietary fiber supplement composition that includes psyllium husk, characterized by its xylitol coating. The invention not only enhances intestinal functions, but can be widely used for treating or preventing colon cancer and obesity.

2. General Background and State of the Art

Due to the introduction of western eating habits such as fast food, which consist of high protein, low fiber diets, into the Korean food culture (which traditional composition is concentrated around vegetarian products), constipation has emerged as a notable health hazard in recent days.

In order to maintain good intestinal health, it is necessary to ingest appropriate amounts of dietary fibers and feel comfortably full after each meal. Doing so increases the amount of feces while decreasing its passage time, which in turn provides an environment in which the intestinal mucous membrane can best function. Conventional fiber supplements for treating constipation are simple products consisting of only one non-aqueous dietary fiber: psyllium, and other supplements that complement the vitamins and minerals that lack such products.

Conventional fiber supplements consist of a combination of psyllium with extraneous materials; characteristically, they tend to expand in volume when mixed with water and make the process of ingestion very inconvenient. Due to the tendency of psyllium to stick to the walls of the oral cavity when ingested in its dried state, it is necessary to mix it with water prior to ingestion, thus adding further inconvenience to its consumption. The unpleasant taste and smell of psyllium husk create further complications, and thus many consumers have come to avoid fiber supplements.

### SUMMARY OF THE INVENTION

The present invention addresses the hereinbefore described shortcomings of plain psyllium as a fiber supplement. While preserving the beneficial dietary effects of psyllium, the invention enables convenient and pleasurable consumption for the consumer. An object of this invention is to provide the manufacturing process of an easily consumable, yet accessible functional dietary fiber supplement that appeals to the senses while enhancing digestive functions and intestinal health.

The present invention meets the objective by providing a xylitol coated functional dietary fiber supplement containing psyllium. The xylitol coating enables convenient and pleasurable consumption of the product without having to mix it in water; instead, the product can be directly ingested with water. The invention corresponds well with the modern trend that seeks portable, easily accessible, and convenient products. When consumed properly, the present invention can contribute greatly to personal health.

These and other objects of the invention will be more fully understood from the following description of the invention, the referenced drawings attached hereto and the claims appended hereto.

### BRIEF DESCRIPTION OF THE DRAWINGS

The present invention will become more fully understood from the detailed description given herein below, and the accompanying drawings which are given by way of illustration only, and thus are not limitative of the present invention, and wherein;

FIG. 1 shows xylitol coated psyllium crystals;

FIG. 2 shows the crystal of uncoated psyllium;

FIG. 3a shows the sedimentation of coated psyllium 10 seconds after it is mixed in water (Example 1);

FIG. 3b shows the sedimentation of coated psyllium 120 seconds after it is mixed in water (Example 1);

FIG. 4a shows the sedimentation of uncoated psyllium 10 seconds after it is mixed in water ( Example 6);

FIG. 4b shows the sedimentation of uncoated psyllium 120 seconds after it is mixed in water (Example 6).

### DETAILED DESCRIPTION OF THE PRESENT INVENTION

The present invention concerns a functional dietary fiber supplement composed of ground psyllium husk coated in xylitol, to be used in treating constipation and ameliorating intestinal function.

As used herein, psyllium husk refers to the outer shell of psyllium seeds, separated and dried. When psyllium husk absorbs water, it exhibits viscosity and expands 40 times its volume, leading to an incremental increase in the amount of feces and accelerating passage through the digestive tract. The amount of fat expelled also increases, consequently lowering cholesterol within the body. The positive effects, as mentioned above, help prevent the occurrence of colon cancer, improve the general health of the digestive tract, and contribute to healthy weight management.

As used herein, the preferred amount of psyllium is 60 to 80 percent respective to the total mass, preferably 65-80%, 65-75%, 65-70%, 70-80%, 70-75%, 74-77%, or 75-80% by weight. An amount composed of less than 60% would be insufficient for the psyllium to deliver all of its beneficial effects, while an amount that exceeds 80% of the total mass would result in a decrease of the amount of xylitol available, thus hindering the effective coating of psyllium; such would in turn lead to a degradation in the taste and effectiveness of the product.

As used herein, the type of psyllium used are those between 20 to 60 mesh; psyllium husks of under 20 mesh are inconvenient to consume due to large particle sizes, while those that exceed 60 mesh complicate the proper coating of the material, thus leading to a degradation in the rates of water-absorption and swelling of psyllium.

As used herein, xylitol refers to the low calorie saccharide derived from birch trees and the cellulose of corn stalks. Xylitol exhibits the same sweetness level as sugar (4.0 kcal/g) but contains far less calories (2.4 kcal/g), and leaves behind a fresh feeling in the mouth due to its high heat of solution, which is 10 times that of sugar. Moreover, xylitol is not decomposed by S. mutans, bacteria that are directly accountable for tooth cavities, and does not produce acid. In fact, xylitol is known to restrain the growth of bacteria and thus deter plaque formation. Other than its application in oral healthcare, xylitol, which does not rely on insulin for decomposition, is also used in preventing diabetes.

As used herein, the proper xylitol content would be between 20 to 40 percent of the total mass, preferably 23-26%, 25-40%, 25-35%, 25-30%, 30-40%, 30-35%, or 35-40% by weight A content of less than 20% results in uneven coating of the contents and thus degrades the taste of the product, while a content that exceeds 40% of the total mass adds unnecessary calories and hinders the psyllium from providing its full benefits.

As alternate embodiments of the invention, various subsidiary ingredients can be added to enhance the flavor and salutary effects of the invention, as long as they do not compromise the invention's original purpose as an effective functional dietary fiber supplement. Additional ingredients can include, but are not limited to, spices (apple, lemon flavored, etc.), breast milk, lactic acid bacteria, marine plant starch (kelp, red algae, etc.), citric acid, vitamin C, ground herbs (arrowroot starch, etc.) and fermented soy bean powder.

The present invention can be manufactured following a three step procedure that involves; 1) liquefying solid xylitol through the action of heat; 2) blending ground psyllium husk with the liquid xylitol; and 3) cooling the product of the xylitol-psyllium mixture.

During the process of liquefying solid xylitol by heating, it is to be noted that xylitol remains stable at high temperatures and remains undamaged even after having been exposed at 120° C. for 9 hours (90% of the time). It is therefore proper to liquefy xylitol at 120° C.˜130° C. for the period of time deemed necessary according to the quantity of xylitol present. Xylitol best liquefies without damaging its chemical composition and property under the above given temperatures.

In order to obtain smooth coating of the ground psyllium particles, the temperature is to be maintained at 50° C. to 110° C., and the time of coating is to be between 5 to 20 minutes, depending on the amount of xylitol and psyllium present. The two components are to be slowly mixed under the conditions given above. The psyllium particles are uniformly coated, and at the end of the process, xylitol coated psyllium crystals are obtained.

The obtained crystals are to be cooled down at warm temperatures. Once the cooling is complete, the products can undergo extraneous processes such as a) the addition of subsidiary ingredients, and b) the assortment of the grains according to their size.

The present invention is not to be limited in scope by the specific embodiments described herein. Indeed, various modifications of the invention in addition to those described herein will become apparent to those skilled in the art from the foregoing description and accompanying figures. Such modifications are intended to fall within the scope of the appended claims. The following examples are offered by way of illustration of the present invention, and not by way of limitation.

### EXAMPLES

### Example 1

### Manufacturing Process for the Inventive Supplement

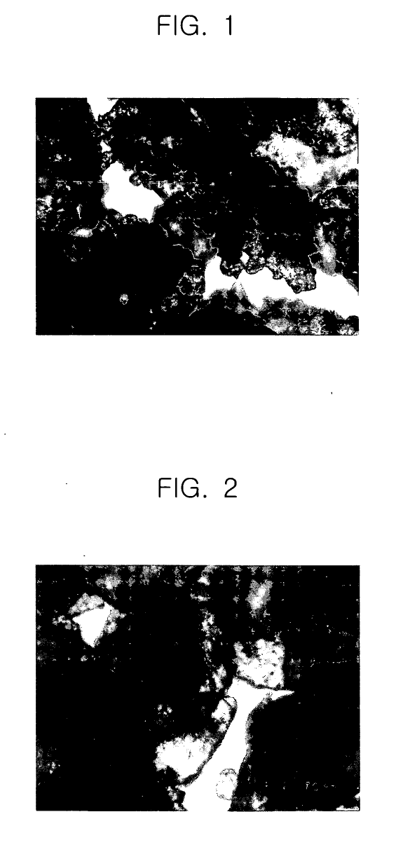

Melt 21.5 g of xylitol powder at 120° C. for 10 minutes until it completely liquefies. Then keep the temperature at 100° C. while adding 78.5 g of 40 mesh ground psyllium husk. Mix the contents together slowly for 5 minutes so that the surface of the psyllium husk is coated with molten xylitol, and cool to 25° C. The results are the crystals as shown in FIG. 1.

### Example 2

### Manufacturing Process for the Inventive Supplement

Melt 20 g of xylitol at 123° C. for 5 minutes, mix 80 g of 30 mesh ground psyllium husk the liquid at 90° C. for 10 minutes to obtain psyllium husk coated with molten xylitol. Cool the xylitol coated psyllium husk to 30° C.

### Example 3

### Manufacturing Process for the Inventive Supplement

Melt 30 g of xylitol at 125° C. for 15 minutes, mix with 70 g of 20 mesh psyllium husk powder at 50° C. for 15 minutes, and cool to 20° C.

### Example 4

### Manufacturing Process for the Inventive Supplement

Melt 40 g of xylitol at 127° C. for 80 minutes, mix with 60 g of 60 mesh psyllium husk powder at 110° C. for 20 minutes, and cool to 25° C.

### Example 5

### Manufacturing Process for the Inventive Supplement

Melt 35 g of xylitol at 130° C. for 20 minutes, mix with 65 g of 50 mesh psyllium husk powder at 70° C. for 10 minutes, and cool to 25° C.

### Example 6

### Uncoated Psyllium

Ground psyllium husk of 40 mesh is prepared. Uncoated psyllium crystals are shown in FIG. 2.

### Example 7

### Sedimentation Comparison

The products obtained from the above mentioned examples, along with the uncoated psyllium, 5 g each, are submerged separately in 100 ml of water at 21° C. No outside force is applied so that the psyllium particles naturally accumulate at the bottom of the beaker. The sedimentation amounts are listed in Table 1.

TABLE 1

| | Ex- | Ex- | Ex- | Ex- | Ex- | Ex- |
|---|---|---|---|---|---|---|
| Time | ample 1 | ample 2 | ample 3 | ample 4 | ample 5 | ample 6 |
| 10 seconds | 25 ml | 24 ml | 26 ml | 28 ml | 26 ml | 0 ml |
| 30 seconds | 50 ml | 54 ml | 52 ml | 56 ml | 54 ml | 0 ml |
| 60 seconds | 62.5 ml | 62 ml | 64 ml | 63 ml | 65 ml | 5 ml |
| 90 seconds | 75 ml | 74 ml | 77 ml | 76 ml | 75 ml | 10 ml |
| 120 seconds | 87.5 ml | 88 ml | 85 ml | 87 ml | 84 ml | 30 ml |

### Example 8

### Taste Preference

10 test subjects were asked to consume the five different products obtained in Examples 1-5, in addition to the uncoated psyllium in its plain state. The test subjects then rated the flavor of the six products from 1 to 5, 1 being the least tasty and 5 the most delectable. Results are summarized in Table 2.

TABLE 2

| Test | Ex- | Ex- | Ex- | | | |
|---|---|---|---|---|---|---|
| Subjects | ample 1 | ample 2 | ample 3 | Example 4 | Example 5 | Example 6 |
| A | 4 | 3 | 4 | 4 | 5 | 1 |
| B | 4 | 4 | 5 | 5 | 5 | 2 |
| C | 5 | 4 | 5 | 5 | 5 | 2 |
| D | 4 | 4 | 4 | 5 | 4 | 1 |
| E | 4 | 4 | 5 | 5 | 5 | 2 |
| F | 4 | 4 | 4 | 5 | 5 | 1 |
| G | 4 | 4 | 5 | 5 | 5 | 1 |
| H | 4 | 3 | 4 | 4 | 4 | 1 |
| I | 4 | 4 | 4 | 5 | 4 | 1 |
| J | 4 | 4 | 5 | 5 | 5 | 2 |
| Average | 4.1 | 3.8 | 4.5 | 4.8 | 4.7 | 1.4 |

Results

### Example 9.1

### Sedimentation Comparison

Measurements indicated that the coated psyllium obtained from Examples 1-5 exhibited strong water absorbance, dissolving into the water and collecting on the bottom of the beaker very quickly. On the contrary, uncoated psyllium was slow to dissolve and deposited at a significantly slower pace.

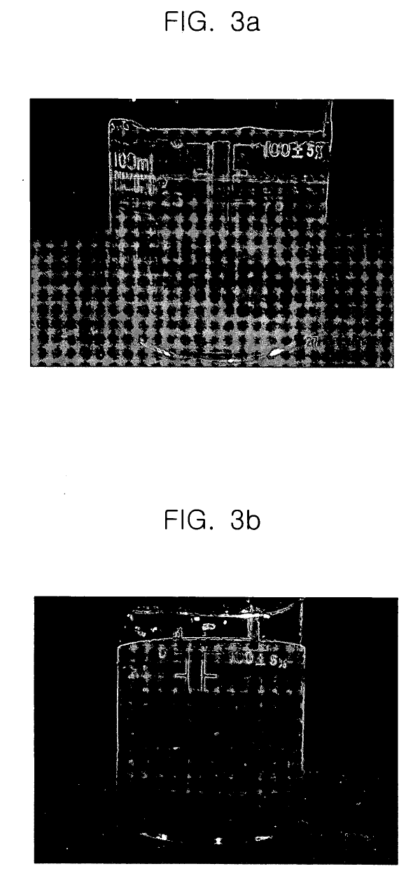

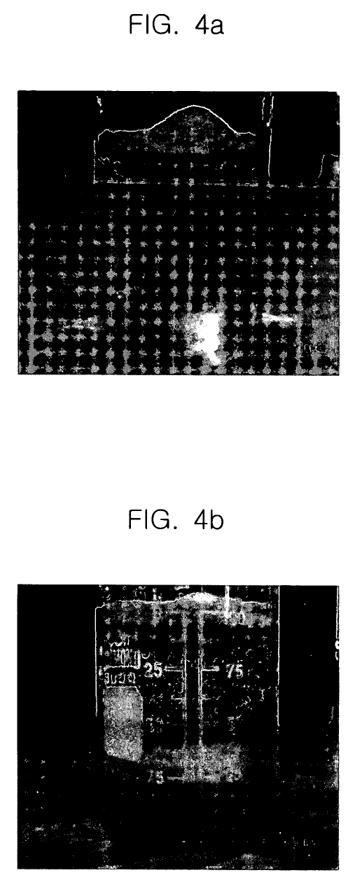

To explain in more detail, total sedimentation of the product obtained in Example 1 occurred within 10 seconds (FIG. 3a), leading to a dilation of volume (40 times its initial volume) after 120 seconds (FIG. 3b). Uncoated psyllium, on the other hand, remained intact for the first 10 seconds, and even after 120 seconds, only a small portion had deposited on the bottom of the beaker.

In other words, the xylitol coated psyllium, unlike plain psyllium, which sticks to the walls (especially the top) of the oral cavity due to its slow dissolution in water, does not instantly dilate when in contact with water, and enables the particles to dissolve into the water easily, thus aiding its smooth passage into the esophagus.

### Example 9.2

### Taste Preference

As Table 2 indicates, the xylitol coated psyllium in Examples 1 through 5 received superior evaluation scores in comparison to the uncoated one. Products with higher xylitol concentration correspondingly received higher scores.

All of the references cited herein are incorporated by reference in their entirety.

Those skilled in the art will recognize, or be able to ascertain using no more than routine experimentation, many equivalents to the specific embodiments of the invention specifically described herein. Such equivalents are intended to be encompassed in the scope of the claims.

1. A functional dietary fiber supplement comprising ground psyllium husk and xylitol coated thereon.

2. The supplement according to claim 1, wherein the ground psyllium husk is present in about 60% to 80% by weight, and xylitol is present in about 20% to 40% by weight.

3. The supplement according to claim 2, wherein the ground psyllium husk is present in about 74-77% by weight, and xylitol is present in about 23-26% by weight.

4. The supplement according to claim 1, wherein the granular size of ground psyllium husk is between about 20 to 60 mesh.

5. A process of making the supplement according to claim 1, comprising: (1) melting xylitol; (2) mixing psyllium granules with molten xylitol; and 3) cooling the resultant mixture in step (2) to produce coated psyllium crystals.

6. The process according to claim 5, wherein the xylitol is molten at a temperature of from about 120° C. to about 130° C.

7. The process according to claim 5, wherein psyllium granules are coated at a temperature of from about 50° C. to about 110° C.

8. The process according to claim 5, wherein the psyllium granules are present in about 60% to 80% by weight, and xylitol is present in about 20% to 40% by weight.

9. The process according to claim 8, wherein the psyllium granules are present in about 74-77% by weight, and xylitol is present in about 23-26% by weight.

10. The process according to claim 5, where in the granular size of psyllium crystals is about 20 to 60 mesh.
